(19) United States
(12) Patent Application Publication
(10) Pub. No.: US 2016/0025007 A1
(43) Pub. Date: Jan. 28, 2016

(54) PLATE HEAT EXCHANGER OF IMPROVED THERMAL EFFICIENCY FOR A TURBOSHAFT ENGINE

(71) Applicant: AIRBUS HELICOPTERS, Marignane (FR)

(72) Inventors: Olivier HONNORAT, Aix En Provence (FR); Christophe DUBOURG, Le Tholonet (FR)

(21) Appl. No.: 14/806,767

(22) Filed: Jul. 23, 2015

(30) Foreign Application Priority Data
Jul. 25, 2014 (FR) 14 01716

(51) Int. Cl. F02C 7/10; F28D 9/00; F28D 1/03

(52) U.S. Cl. CPC F02C 7/10; F28D 1/0308; F28D 9/0031

(57) ABSTRACT

A plate heat exchanger having a plurality of plates with sinusoidal undulations and two chimneys positioned at two opposite corners of the plates. Modules are formed by assembling together pairs of plates, the modules being stacked so as to make contact via the inlet and outlet chimneys in order to form the heat exchanger. The sinusoidal undulations form a first angle β with the flow direction of the fluids in the heat exchanger, the first angle β increasing in the flow direction of a first fluid through the modules. Furthermore, each plate has two distribution zones for distributing the first fluid in the modules in the proximity of each inlet or outlet chimney in order to make the filling and the discharge of the modules by the first fluid more uniform.

### CROSS REFERENCE TO RELATED APPLICATION

This application claims priority to French patent application No. FR 14 01716 filed on Jul. 25, 2014, the disclosure of which is incorporated in its entirety by reference herein.

### BACKGROUND OF THE INVENTION

(1) Field of the Invention

The present invention lies in the field of heat exchangers. The invention relates to a plate heat exchanger of improved thermal efficiency in which two fluids flow preferably as counter-flows. The heat exchanger is particularly intended for heating admission air to a gas turbine of an aircraft. The invention also relates to a gas turbine fitted with the heat exchanger and to a rotary wing aircraft, such as a helicopter, powered by one or more such gas turbines.

(2) Description of Related Art

It is known that the efficiency of gas turbines is relatively low. In particular with turboshaft engines, the particular type of gas turbine engines conventionally used for rotary wing aircraft, this efficiency is of the order of 25%.

One known solution for improving efficiency is to heat the air after it has been compressed and before it is admitted into the combustion chamber of the turboshaft engine. This makes it possible to reduce the requirement for heat in the combustion chamber, and consequently to reduce the fuel consumption of the engine.

The admission air can be heated in particular by using the heat of the exhaust gas leaving the turbine, this heat generally being unused. For this purpose, appropriate heat exchangers are used in particular in industrial power plants.

However, applying such heat exchangers to the specific field of aircraft turboshaft engines encounters several major problems, in particular the weight and the volume of such heat exchangers and the loss of power of the engine using such a heat exchanger.

The exhaust gas leaves the turbine at high speed, and causing it to flow through a heat exchanger that recovers a portion of its heat leads to significant head losses in the flow of the exhaust gas, thereby leading to a loss of engine power.

Furthermore, the volume available in an aircraft is small, so installing a heat exchanger on an engine leads to problems of bulk. Finally, weight is also an important criterion that affects the performance of the aircraft.

Document FR 2 280 870 describes a heat exchanger for which the two fluids flow as counter-flows. That heat exchanger is made of metal plates, e.g. aluminum plates, having regular undulations. The undulations are mutually parallel and perpendicular to the flows of the two fluids.

The two cavities constituted by those plates have the same volume, with the spacing between the plates being constant and ensured by spacers and by bulges on each plate. Sealing between the plates is obtained by using synthetic plastics material, with the plates being fastened together by crimping.

Document U.S. Pat. No. 6,016,865 discloses a plate heat exchanger for exchanging heat between a first fluid at a high pressure and at a low flow rate and a second fluid at a low pressure and at a high flow rate. Each plate has projecting and set-back shapes forming V-shapes that are inclined relative to the flows of the fluids. Those shapes are also inclined relative to each other on two adjacent plates.

The plates are assembled together in pairs by welding or brazing, for example, at their peripheral zones and at points of contact between the set-back shapes in order to form modules. The modules are then stacked on one another, making contact via bulges. Thus, the fluids can flow in two independent volumes, allowing heat to be exchanged between them.

Furthermore, Document EP 1 122 505 describes a plate heat exchanger in which the plates are grouped together in pairs are and positioned in a casing. Furthermore, each plate has a plurality of chimneys, and once the chimneys are grouped together, they form inlet pipes and outlet pipes for the heat exchanger.

Also known is Document FR 2 866 699, which describes a plate heat exchanger formed by ribbed metal plates that are welded together. Each plate has end zones in which the ribs are rectilinear and mutually parallel, and a central zone in which the ribs are of V-shape.

Furthermore, Document WO 83/01998 describes a plate heat exchanger having troughs and ridges. The plates are in contact via the points of contact between the ridges of two adjacent plates. These ridges have stamped zones that limit the number of the points of contact between two adjacent plates, thereby reducing the head losses generated in the fluid flowing between the plates.

Finally, Document FR 2 988 822 is known, which describes a heat exchanger having a plurality of plates. Each plate has a multitude of parallel sinusoidal undulations of different heights, and each plate has two chimneys. The plates are associated in pairs, making contact via the undulations of smaller height, and the modules formed by these pairs of plates come into contact via the undulations of greater height. The various undulations contribute to stirring the fluids, thus improving heat exchange between them. The plates of that heat exchanger are of small thickness and made of Inconel®.

Those various plate heat exchangers are usable in an engine, since their volumes and their weights are of reasonable proportions. Nevertheless, they are not suitable for satisfying all of the constraints generated by a turboshaft engine of a rotary wing aircraft.

Apart from the above-mentioned constraints concerning volume and weight, the exhaust gas from a turboshaft engine is extremely hot, having a temperature of about 700° degrees Celsius (° C.). As a result, the elements constituting the heat exchanger must be capable of withstanding such temperatures. Furthermore, on starting the engine, the rise in temperature is very large and fast, with temperature going from about 15° C. to about 700° C. within about ten seconds inside the heat exchanger, and in particular in each module constituted by two associated plates.

Furthermore, the temperature difference between the exhaust gas and the admission air is large, being of the order of 300° C., and possibly closer to 600° C. when the engine is starting. Likewise, the pressure difference between the two fluids is large, with the exhaust gas leaving the turbine at atmospheric pressure, whereas the admission air enters the heat exchanger at a pressure lying in the range 6 bars to 11 bars.

These differences of pressure and temperature between the two fluids gives rise to thermal and mechanical stresses in the heat exchanger that can give rise in particular to deformations and/or cracks in the components of the heat exchanger and also to cracking or breaking in the welds. Consequently, the sealing of the heat exchanger modules can deteriorate, with leaks appearing between the modules.

Furthermore, in order to have good thermal efficiency for the heat exchanger, i.e. large capacity for transmitting heat from the exhaust gas to the admission air, the fluids must flow over a large heat exchange area that presents good heat exchange. Consequently, thermal convection between the two fluids is important.

In addition, in order to make better use of the heat exchange area, it is important to have the fluids distributed uniformly over the heat exchange areas as from the moment they enter the heat exchanger. Nevertheless, depending on the location of the heat exchanger, in particular for its use with an aircraft turboshaft engine, and given its size, the plates constituting the heat exchanger can be quite large. In addition, depending on their locations, the inlet and outlet pipes can be more or less offset relative to the width of the plates.

Consequently, the distribution of the first fluid is not uniform across the width of the plates of the heat exchanger, the first fluid spreading naturally around the inlet pipe so as to go as quickly as possible towards the outlet pipe. Thus, a zone that is to be found directly between an inlet pipe and an outlet pipe is very well fed with the first fluid, whereas a zone that is offset from the inlet and/or outlet pipe is less well fed.

An inverse phenomenon can also occur at the junctions between the plates and the outlet pipes. The first fluid in certain zones of the plates then discharges more easily and quickly than from other zones that are farther away and/or offset from the outlet pipes. Heat exchange between the fluids is then more effective in those zones of the plates that fill and discharge quickly compared with the other zones.

In addition, stirring the fluids leads to an increase in convection between the fluids and consequently also enables heat exchange to be improved. However, such stirring causes the fluids to flow in turbulent manner, thereby giving rise to head losses that can be large. The head losses of the fluids flowing through the heat exchanger and the heat exchange coefficients between the fluids are thus directly related.

In particular, head losses in a fluid are proportional, to the first order, to the square of the speed of the fluid. Thus, since admission air is flowing at a low speed, the head losses to which it is subjected are very small. In contrast, the head losses in the exhaust gas are particularly great, since the gas leaves the turbine at high speed. These head losses then give rise to the engine losing power, and that is harmful, in certain particular stages of flight, such as stages of takeoff, landing, and hovering.

The performance of the heat exchanger is associated, amongst other things, with the compromise between the head losses in the fluid flowing through the heat exchanger and in particular the exhaust gas, and the heat exchange coefficient.

The head losses of a fluid flowing in a turbulent regime are associated in particular with the Reynolds' number Rₑ of the fluid. The Reynolds' number Rₑ characterizes the flow, and in particular the nature of its flow regime, which may in particular be laminar, transitional, or turbulent. The Reynolds' number Rₑ depends mainly on the speed of the fluid, on its density, and on its dynamic viscosity. For a flow in a heat exchanger, the speed, the density, and the viscosity of a fluid depend directly on its temperature, which is thus a key parameter that causes the Reynolds' number Rₑ to vary.

It is known that in order to maximize the use of the heat exchange area between two fluids in a heat exchanger and thereby optimize the effectiveness of the heat exchanger, it is important to conserve a Reynolds' number Rₑ that is constant along the heat exchanger so as to retain a heat exchange coefficient that is constant with head losses that are likewise substantially constant.

Nevertheless, the temperature of the fluids flowing through the heat exchanger generally varies along the heat exchanger, giving rise to variation in the Reynolds' number Rₑ of the fluid. In particular, in a heat exchanger for an aircraft, the temperature of the admission air increases by about 200° C. on passing through the heat exchanger, thereby leading to a large variation in its Reynolds' number Rₑ, and consequently to a drop in the efficiency of heat exchange.

### BRIEF SUMMARY OF THE INVENTION

An object of the present invention is thus to propose a plate heat exchanger making it possible to be unaffected by the above-mentioned limitations and more particularly to improve the effectiveness of heat exchange between the fluids flowing through the heat exchanger.

According to the invention, a heat exchanger has a plurality of modules, each made up of two metal plates. Each plate has a peripheral zone, at least one inlet chimney, at least one outlet chimney, and a crenellated inner zone made up of ridges and troughs.

The peripheral zone is preferably plane and then forms a lower plane P1 in which the bottoms of the troughs are located. Each inlet chimney and each outlet chimney rises from the peripheral zone to an upper plane P2 parallel to the lower plane P1. The ridges are situated in an intermediate plane P3 parallel to the lower and upper planes P1 and P2. The intermediate plane P3 may be situated between the lower and upper planes P1 and P2 or it may coincide with the upper plane P2.

The plates are assembled in pairs to form modules. The two plates of a pair come into contact firstly via their peripheral zones and secondly at the points of contact between the troughs. The two plates are fastened together firstly at their points of contact in their peripheral zones and secondly at least one point of contact between their troughs.

By way of example, the two plates may be fastened together by welding or preferably by brazing.

The heat exchanger of the invention is formed by stacking a plurality of modules so that two adjacent modules come into contact at least via their inlet and outlet chimneys. These two adjacent modules may optionally also come into contact via at least one point of contact between their ridges. The adjacent modules are fastened together, e.g. by welding, or preferably by brazing.

The heat exchanger of the invention also has a casing in which the modules are housed, the casing having a plurality of walls.

In addition, each extreme module of the stack of modules is fastened to a wall at least via each inlet chimney and each outlet chimney by welding, or preferably by brazing. The term “extreme module” is used to designate the first or the last module in the stack of modules of the heat exchanger.

In such a heat exchanger, the directions of the troughs and of the ridges on each plate lie at a first angle β relative to the flow direction of the fluids through the heat exchanger, and the directions of the troughs and of the ridges of two adjacent plates form a non-zero second angle relative to each other.

An inlet pipe of the heat exchanger is formed by assembling together one of the inlet chimneys of each of the plates constituting the module. Likewise, an outlet pipe is formed by assembling together one of the outlet chimneys of each of the plates.

The heat exchanger thus has one or more inlet pipes and one or more outlet pipes. The heat exchanger has as many inlet pipes as the plates constituting the modules and inlet chimneys and as many outlet pipes as the plates have outlet chimneys.

Openings are arranged in at least one wall of the casing to enable a first fluid to enter into each inlet pipe and to enable this first fluid to leave each outlet pipe. Two additional openings are arranged in the casing to form an inlet and an outlet of the heat exchanger so as to enable a second fluid to enter and exit the heat exchanger.

A first cavity is constituted by the inside space of a module, i.e. by the space between the two plates of the module. The first cavities are connected together by means of each inlet pipe and of each outlet pipe. One end of each inlet pipe and of each outlet pipe opens out outside the heat exchanger via openings arranged in the walls of the casing. The first fluid then flows throughout all of the first cavities in the modules of the heat exchanger and between each inlet pipe and each outlet pipe.

A second cavity is constituted mainly by the space between two adjacent modules and also by the space between each extreme module and a wall of the casing.

A third cavity is constituted by the space situated between the peripheral zones of the modules and the walls of the casing. The second fluid can also flow in this third cavity.

The second cavities are connected together in particular via the inlet and the outlet of the heat exchanger and also via the space at the periphery of each plate constituting the third cavity. The flow of the second fluid is limited by the walls of the casing. The second fluid then flows throughout the second cavities of the modules of the heat exchanger between the inlet and the outlet of the heat exchanger.

The second fluid can thus flow parallel to the first fluid and preferably in the opposite direction to the first fluid. Such a heat exchanger is known as a counter-flow heat exchanger. Nevertheless, the second fluid can also flow parallel with and in the same direction as the first fluid: this constitutes a parallel flow heat exchanger.

The device is remarkable in that each plate of the heat exchanger of the invention has a distribution zone in the proximity of each inlet chimney and of each outlet chimney. Such a distribution zone situated between the crenellated inner zone and the inlet chimney makes it easier to fill a module with the first fluid. Likewise, such a distribution zone situated between the crenellated inner zone and an outlet chimney makes it easier to discharge the first fluid from the module.

Each distribution zone has channels in which the first fluid can flow firstly from an inlet chimney towards the crenellated inner zone and secondly from the crenellated inner zone towards an outlet chimney. These channels are oriented in the proximity of an inlet chimney so as to feed all of the crenellated inner zone of a plate in substantially uniform manner. Likewise, these channels are oriented in the proximity of an outlet chimney so as to empty all of the crenellated inner zone of a plate in substantially uniform manner.

These channels may be of varying orientations depending on their positions firstly around the inlet chimney or the outlet chimney and secondly in the proximity of the crenellated inner zone.

In particular, the channels may be oriented in different directions in different portions of the distribution zone.

For example, it is possible to separate the distribution zone into two portions. A first portion is constituted by the space situated between the inlet chimney or the outlet chimney and the crenellated inner zone in the flow direction of the first fluid. A second portion is constituted by the remainder of the distribution zone, i.e. the space situated around the inlet or outlet chimney, in this distribution zone and outside the first portion.

The channels are then preferably parallel to the flow direction of the first fluid through the heat exchanger in the first portion of the distribution zone. In contrast, in the second portion of the distribution zone, these channels are preferably inclined relative to the flow direction of the first fluid in the proximity of the inlet or outlet chimney. Thereafter, in this second portion of the distribution zone, the channels are parallel to the flow direction of the first fluid in the proximity of the crenellated inner zone, thus making it possible to fill, or empty as the case may be, the crenellated inner zone directly.

Each distribution zone is as narrow as possible so as to maximize the area of the crenellated inner zone. The exchange of heat between the first and second fluids is at a maximum in the crenellated inner zone. Heat exchange between the first and second fluids can nevertheless take place in the distribution zones, but this heat exchange is not optimized, since the channels in the distribution zone are not adapted to exchanging heat.

The principle on which the channels in the distribution zones operate is to distribute the first fluid uniformly over the entire width of the crenellated inner zone, while minimizing the head losses induced by the distribution zone. These channels also serve to discharge the first fluid effectively and in uniform manner from the crenellated inner zone while likewise minimizing the head losses induced by the distribution zone.

Unlike the crenellated zones of two adjacent plates in which the directions of the troughs and the ridges intersect so as to form a second angle θ, the channels in the distribution zones of two adjacent plates are parallel and identical. Thus, when assembling together two plates forming a module, the channels in each plate face one another in pairs and are grouped together so as to constitute ducts, thereby facilitating feeding and discharging the first fluid to or from the crenellated inner zone of these two adjacent plates.

In addition, the two adjacent plates are fastened together, e.g. by welding, or preferably by brazing, so as to form a module. Advantageously, the channels of these two adjacent plates extend parallel, thus making it possible to have a plurality of fastening points between the plates in each distribution zone. Advantageously, the fastening of a module is thus improved over each distribution zone, i.e. in the proximity of the inlet and outlet chimneys, as compared with a heat exchanger in which the fastening points of a module are situated at the intersections between the troughs of two adjacent plates. Thus, the modules of the heat exchanger of the invention have better ability to withstand the static pressure of the first fluid flowing in each module.

The distribution zone may also have a furrow into which the channels open out. The furrow is situated at the junction between the distribution zone and the crenellated inner zone. The troughs and the ridges of the crenellated inner zone open out at opposite sides of the crenellated inner zone respectively into at least one furrow in at least one distribution zone. Thus, the troughs and the ridges of the crenellated inner zone begin in the furrow of at least one distribution zone and terminate in the furrow of at least one other distribution zone. Thus, the furrow also contributes to making more uniform the filling or the discharging of the crenellated inner zone of a module by the first fluid.

The channels can be of various shapes. The uniformity with which the first fluid is fed over the entire crenellated inner zone of a module and with which is it discharged from the crenellated inner zone of the module is a function of a section of each channel and also of the area of the crenellated inner zone fed by each channel. Thus, the greater the area of the crenellated inner zone fed by a channel, the greater must be the section of the channel in order to guarantee uniform distribution of the first fluid over the entire crenellated inner zone by means of the set of channels in the distribution zone.

The channels are preferably only recessed in each of the plates, with the depth of the channels being constant over a plate and identical for each channel. In order to fill the crenellated inner zone of a module in uniform manner, the greater the area of the crenellated inner zone that is fed by the channel the greater must be the width of the channel. In practice, the width of a first recessed channel is greater than the width of a second recessed channel when the first channel feeds a larger area of the crenellated inner zone than does the second channel.

Furthermore, a channel may split into a plurality of secondary channels in the distribution zone in order to be more effective in filling or discharging the crenellated inner zone. The secondary channels open out into the crenellated inner zone, whereas the channel from which the secondary channels stem opens into an inlet chimney or an outlet chimney. This splitting of a channel is of use in particular when the channel feeds a large area of the crenellated inner zone. The secondary channels thus make it possible to fill or discharge in uniform manner this large area of the crenellated inner zone.

In another embodiment of the invention, each channel may be formed by a distribution trough and a distribution ridge. The distribution trough and the distribution ridge may be of the same shape and in continuity with the troughs and the ridges of the crenellated inner zone. Nevertheless, the distribution ridges are of height that is greater than that of the ridges of the crenellated inner zone in order to enable the first fluid to be distributed uniformly in the crenellated inner zone. The height of these distribution ridges decreases down to the crenellated inner zone. In contrast, the distribution troughs and the troughs in the crenellated inner zone have the same depth. In this embodiment, the distribution zone is preferably located in the zone of the plate for which the distance between an inlet or outlet chimney and the crenellated inner zone is relatively large.

The use of this distribution zone one each plate in the proximity of each inlet chimney enables the first fluid to be distributed in uniform manner throughout the crenellated inner zone. Likewise, the use of this distribution zone in each plate in the proximity of each outlet chimney enables the first fluid to be discharged in uniform manner from the entire crenellated inner zone. Thus, by optimizing the feeding and the discharging of the crenellated inner zone of each module, heat exchange between the first and second fluids is considerably improved compared with a conventional heat exchanger. Advantageously, this optimization is obtained without increasing the volume of the heat exchanger, and without adding additional components. As a result, the weight of such a heat exchanger is not increased, while its thermal efficiency is nevertheless improved, which is of great importance, in particular for an application on board a rotary wing aircraft.

Finally, in a variant of the heat exchanger of the invention, in order to avoid generating large unwanted head losses in the second fluid flowing between the inlet and the outlet of the heat exchanger in contact with these distribution zones, secondary ducts may be added to each distribution zone. The second fluid flows at high speed in the second cavities. As a result, the second fluid is very sensitive to head losses. The channels of this distribution zone and the spaces between these channels can generate such head losses.

In a first variant of the heat exchanger, the secondary ducts are projections oriented in a direction substantially parallel to the flow direction of the second fluid of the heat exchanger. The term “projection” is used to designate shapes formed by stamping in a direction opposite to that of the channels, with the channels constituting indentations. These secondary ducts are situated in the channels that are inclined relative to the flow direction of the second fluid and they locally reduce the height of these channels. The second fluid can then flow in the secondary ducts in order to cross each distribution zone, thus locally reducing the appearance of head losses in the second fluid.

In a second variant of the heat exchanger, the secondary ducts are projections or oriented in a direction substantially parallel to the flow direction of the second fluid in the heat exchanger. These secondary ducts are situated between the channels that are inclined relative to this flow direction of the second fluid, thereby reducing the depth of the spaces between the channels in which the second fluid can flow. The turbulence generated by the presence of these channels in the second fluid is thus locally decreased, thereby limiting the appearance of head losses in the second fluid.

Advantageously, these secondary ducts in this second variant also create passages between the channels that can also improve the flow of the first fluid in the channels, e.g. avoiding an effect of the flow of the first fluid becoming saturated in certain channels.

In addition, the first angle β between the directions of the troughs and the ridges in each plate and the directions of the flows of the fluids can vary in the heat exchanger.

Within the heat exchanger, heat exchange between the two fluids flowing in the first and second cavities takes place through the plates, the two fluids flowing in parallel on opposite sides of the plates, and preferably in opposite directions in order to obtain better exchanges of heat.

Furthermore, the shapes of the troughs and of the ridges of the plates have an effect on the heat exchange between the two fluids.

The performance of the heat exchange between the two fluids depends in particular on a compromise between the head losses to which the fluids are subjected and the heat exchange coefficient. An increase in head losses leads to an increase in convection between the fluids and consequently to an increase in heat exchange, and as a result an increase in the effectiveness of heat exchange. These parameters thus depend directly on the shapes of the troughs and the ridges, and also on their dimensions.

The troughs and the ridges can thus take on a variety of shapes as are conventionally used in a heat exchanger. These various shapes may in particular be imposed by the material from which the plates are made and any constraint involved with shaping these plates and also with optimizing exchanges of heat between the first and second fluids.

By way of example, the troughs and the ridges in the plates may be in the form of rectangular section squarewaves or trapezoidal section waves. The ridges and the troughs may also be sinusoidal undulations. Such sinusoidal undulations contribute to good flows of the first and second fluids in the first and second cavities and they make it possible to distribute the pressure of each fluid uniformly over each surface of the plates. These shapes have neither edges nor sharp angles. The fluids can follow the undulations and thus enhance exchanges of heat while limiting head losses generated by these shapes in the first and second fluids.

Furthermore, the troughs and the ridges in a plate may all be in a single direction such as a straight line over the entire plate.

In contrast, the troughs and the ridges in a plate may follow directions that intersect over the entire plate. For example, the troughs and the ridges may have two intersecting directions thus forming V-shapes, i.e. each trough and each ridge in a plate is constituted by two lines forming a V-shape, with these two lines forming an acute angle between each other. Such troughs and ridges in the form of V-shapes are generally positioned so as to be substantially symmetrical relative to the flow direction of the fluids in the heat exchanger. Thus, each of the two lines constituting a V-shape forms a first angle β with the fluid flow direction.

Naturally, other shapes may be envisaged for the troughs and the ridges in the plates. Nevertheless, these shapes must be compatible with making and stacking modules and with allowing the first and second fluids to flow.

Furthermore, in order to have a good compromise between heat exchange and head losses, the ridges and the troughs in the plates form a first angle β with the flow direction of the two fluids. If the directions of the troughs and the ridges were to be parallel to the flow direction of the fluids, then their effects on head losses would be minimal, however they would give rise to little movement within the fluids. They would therefore not encourage turbulence, and consequently they would not encourage heat exchange between the fluids.

In contrast, if the directions of the troughs and the ridges were to be perpendicular to the flow direction of the fluids, they would generate a large amount of movement and thus a large amount of turbulence in the fluids, thereby enhancing exchanges of heat. In contrast, their effects on head losses would be large.

Consequently, in order to have a good compromise that enables acceptable levels of turbulence to be generated in the two fluids and consequently good heat exchange, while limiting head losses in the two fluids, the directions of the troughs and of the ridges are inclined relative to the flow direction of the two fluids by a first angle β that is acute. For example, this first angle β between the directions of the troughs or of the ridges and the flow direction of the two fluids lies in the range 30° to 60°.

Likewise, a second angle θ between the directions of the troughs and of the ridges in two adjacent plates has effects on the turbulence in the flows of the two fluids and on the head losses of the fluids. In the same manner as above, and in order to obtain a good compromise between head losses and turbulence, and consequently good heat exchange, this second angle θ between the directions of the troughs and the ridges of two adjacent plates should be non-zero angle. This second direction θ between the directions of the troughs and the ridges of two adjacent plates preferably lies in the range 60° to 120°.

Furthermore, it is known that in order to optimize the effectiveness of heat exchange, it is important to conserve a Reynold's number Rₑ that is substantially constant in the fluids along the heat exchanger, this Reynold's number Rₑ also varying with the temperature of the fluid.

The temperatures of the fluids flowing through the heat exchanger can vary considerably, in particular in a heat exchanger fitted to a turboshaft engine of a rotary wing aircraft. For example, the first fluid is constituted by air for admission to the combustion chamber of the engine, this admission air being taken on leaving a compressor, and the second fluid is constituted by the exhaust gas leaving the combustion chamber. The temperature of the admission air can then increase by about 200° C. going through the heat exchanger, leading to a large variation in the Reynolds' number Rₑ of the first fluid. Likewise, the temperature of the exhaust gas can also decrease by a value of the order of 200° C. to 250° C. on passing through the heat exchanger, leading to a large variation in the Reynolds' number Rₑ of the second fluid.

The shapes and the dimensions of the plates are generally defined depending on the flow rates of the first and second fluids flowing in the first and second cavities and as a function of the head losses that appear in the fluids. In particular, the distance between the bottoms of the troughs and the tops of the ridges corresponding to the depth to which the plates are stamped needs to be as large as possible, and the pitch between these troughs and these ridges needs to be as small as possible, in order to maximize the heat exchange area between the first and second fluids. This height and this pitch are generally limited by the characteristics of the material from which the plates are made.

Advantageously, the first angle β formed between the direction of the troughs and of the ridges and flow direction of the fluids in the heat exchanger can then be used to compensate for the variation in the temperatures of the fluids through the heat exchanger. If this first angle β increases during the progress of a first fluid through the heat exchanger and its increase in temperature, then the first fluid is subjected to less turbulence as it progresses through the heat exchanger and therefore conserves a Reynolds' number Rₑ that is substantially constant.

Furthermore, the heat exchange coefficient of the first fluid that heats up has greater influence on the effectiveness of the heat exchanger than the heat exchange coefficient of the second fluid that cools down. Thus, in the heat exchanger of the invention, the first angle β increases in the flow direction of the first fluid through the first cavities in order to maximize the heat exchange coefficient of the first fluid.

For example, the variation in this first angle β lies in the range 5° to 20° between an inlet chimney and an outlet chimney of a plate. Preferably, the variation of this first angle β is equal to 10° from the inlet pipe to the outlet pipe of the heat exchanger.

In addition, the second fluid preferably flows at a counter-flow relative to the first fluid in the heat exchanger of the invention, and the first angle β decreases in the flow direction of the second fluid. As a result, the decrease in the temperature of the second fluid on passing through the heat exchanger can then be compensated at least in part by the decrease in this first angle β in the flow direction of the second fluid, advantageously contributing to optimizing the exchange of heat between the first and second fluids in the heat exchanger of the invention.

The heat exchanger of the invention may also, in known manner, have a plurality of combs situated in the third cavity. These combs serve to steer the second fluid towards the second cavities and also to maintain the spacing between the modules.

In addition, movable flaps can be positioned in the first cavity between the modules and at least one of the walls. Depending on their positions, these movable flaps enable the flow of the second fluid to take place for the most part in the third cavity or else in the second cavities.

Various materials such as mild steel or aluminum can be used for making the plates of the heat exchanger of the invention. Nevertheless, in order to withstand as well as possible the stresses to which the heat exchanger is subjected, in particular when it is fitted to an aircraft turboshaft engine, the plates may be made using a material known under the name “Inconel®”.

Furthermore, in order to ensure that the heat exchanger as a whole remains homogeneous in terms of material and thermal expansion, in particular, the walls of the casing and possibly also the combs and the flaps, if any, may also be made of Inconel®. These components may be assembled together by brazing using Inconel®, or a metal very close to Inconel®.

Furthermore, the invention also provides a gas turbine fitted with such a heat exchanger. The first fluid is then constituted by the admission air for the combustion chamber of the turbine, coming from a compressor, and the second fluid is constituted by the exhaust gases leaving the turbine.

The gas turbine has at least one cold volute and at least one hot volute. The cold volute enables the admission air to flow from the compressor of the turbine to the inlet pipe of the heat exchanger, while the hot volute allows the admission air to flow from the outlet pipe of the heat exchanger to the combustion chamber of the turbine.

The gas turbine also has at least one intermediate nozzle and an outlet nozzle. The exhaust gas leaves the turbine via the intermediate nozzle and is directed to the inlet of the heat exchanger, and after the exhaust gas has left the outlet of the heat exchanger the outlet nozzle directs it away from the turbine.

The heat exchanger may be installed in line with the turbine or beside the turbine. For the in-line case, the exhaust gas is directed directly to the heat exchanger after leaving the turbine, but the volume of such a gas turbine and heat exchanger assembly is very large.

For the beside case, the exhaust gas needs to be directed towards the heat exchanger located beside the gas turbine. For that purpose, the intermediate nozzle has a bend of a shape appropriate to direct the exhaust gas while minimizing head losses. The assembly of the gas turbine and the heat exchanger then has a volume that is more compact than in the in-line configuration, and it may for example be incorporated in an aircraft.

In order to withstand thermal and mechanical stresses while providing the sealing necessary for good operation of the heat exchanger, metal bellows are arranged at the junction between the heat exchanger and the various elements of the gas turbine.

Since the heat exchanger is in a high temperature environment, all of the components of the heat exchanger and of the engine are subjected to expansion. The bellows serve to mitigate such expansions. The environment of the heat exchanger is also subjected to a large amount of vibration. Once more, the bellows serve to absorb such vibration.

The bellows are to be found in particular at the outlet nozzles from the turbine and at the outlet from the heat exchanger for the exhaust gas, and also at the cold and hot volutes that are connected respectively to the inlet and outlet pipes for admission air. The bellows are preferably made of Inconel®.

Finally, the invention also provides a rotary wing aircraft including at least one gas turbine provided with a heat exchanger of the invention.

### BRIEF DESCRIPTION OF THE SEVERAL VIEWS OF THE DRAWINGS

The invention and its advantages appear in greater detail from the context of the following description of embodiments given by way of illustration and with reference to the accompanying figures, in which:

FIG. 1 shows a heat exchanger plate;

FIG. 2 shows a heat exchanger module;

FIG. 3 shows how plates are stacked in a module;

FIGS. 4 and 5 show a heat exchanger of the invention;

FIGS. 6 and 7 show two different views of a distribution zone of a heat exchanger;

FIG. 8 shows another embodiment of the distribution zone;

FIG. 9 shows another heat exchanger plate; and

FIGS. 10 and 11 show a gas turbine having a heat exchanger.

Elements present in more than one of the figures are given the same references in each of them.

### DETAILED DESCRIPTION OF THE OF THE INVENTION

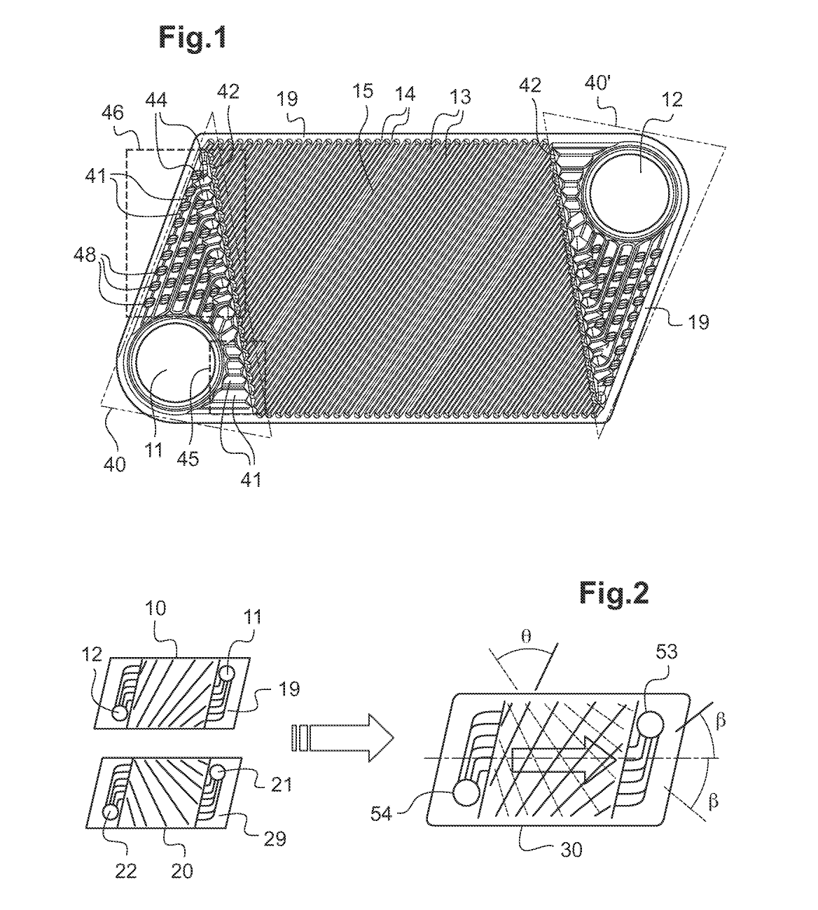

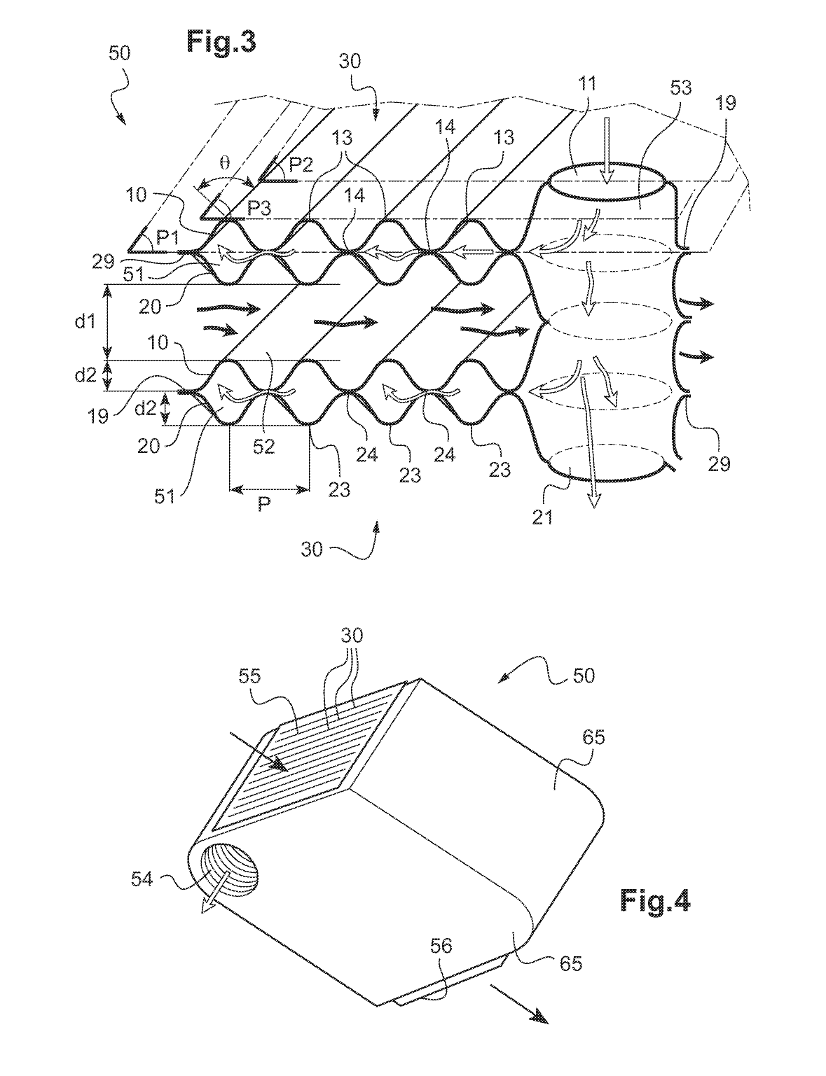

FIG. 1 shows a plate 10 having a plane peripheral zone 19 with two distribution zones 40 and 40′, and a crenellated inner zone 15 having sinusoidal undulations with ridges 13 and troughs 14. An inlet chimney 11 and an outlet chimney 12, located in two opposite corners of the plate 10 project from the peripheral zone 19 to a upper plane P2, as can be seen in FIG. 3.

The peripheral zone 19 forms a lower plane P1 in which the troughs 14 are situated. The ridge undulations 13 are situated in an intermediate plane P3, the intermediate plane P3 being positioned between the lower and upper planes P1 and P2 and being parallel to these planes P1 and P2.

As shown in FIG. 2, a module 30 is formed by assembly the plate 10 with a plate 20. The ridges 13 and the troughs 14 of the first plate 10 co-operate with the ridges 23 and the troughs 24 of the second plate 20 to form second angle θ lying in the range 60° to 120°.

In FIG. 3, there can be seen the points of contact between the plates 10 and 20 and the way the modules 30 are stacked. The plates 10 and 20 make contact via the troughs 14, 24 and their peripheral zones 19, 29. They are fastened together by brazing at these points of contact so as to form the modules 30.

The modules 30 are stacked on one another to form a heat exchanger 50 of the invention. They are in contact via the inlet chimneys 11, 21 and the outlet chimneys 12, 22. The modules 30 are assembled together by brazing at these points of contact.

The inlet chimneys 11, 21 of each plate 10, 20 are thus connected together and form an inlet pipe 53 of the heat exchanger 50. Likewise, the outlet chimneys 12, 22 form an outlet pipe 54.

The ridges 13 of the plates 10, 20 of two adjacent modules 30 are spaced apart by a non-zero first distance d1. A second distance d2 corresponds to the distance between the tops of the ridges 13 and the bottoms of the troughs 14 of each plate 10, 20, i.e. the distance between the lower plane P1 and the intermediate plane P3 of a plate 10, 20.

By way of example, the first distance d1 lies in the range 2 millimeters (mm) to 3 mm, while the second distance d2 lies in the range 3 mm to 4 mm. The thickness of the plates 10, 20 lies in the range 0.1 mm to 0.25 mm, and these plates 10, 20 may be made of Inconel®.

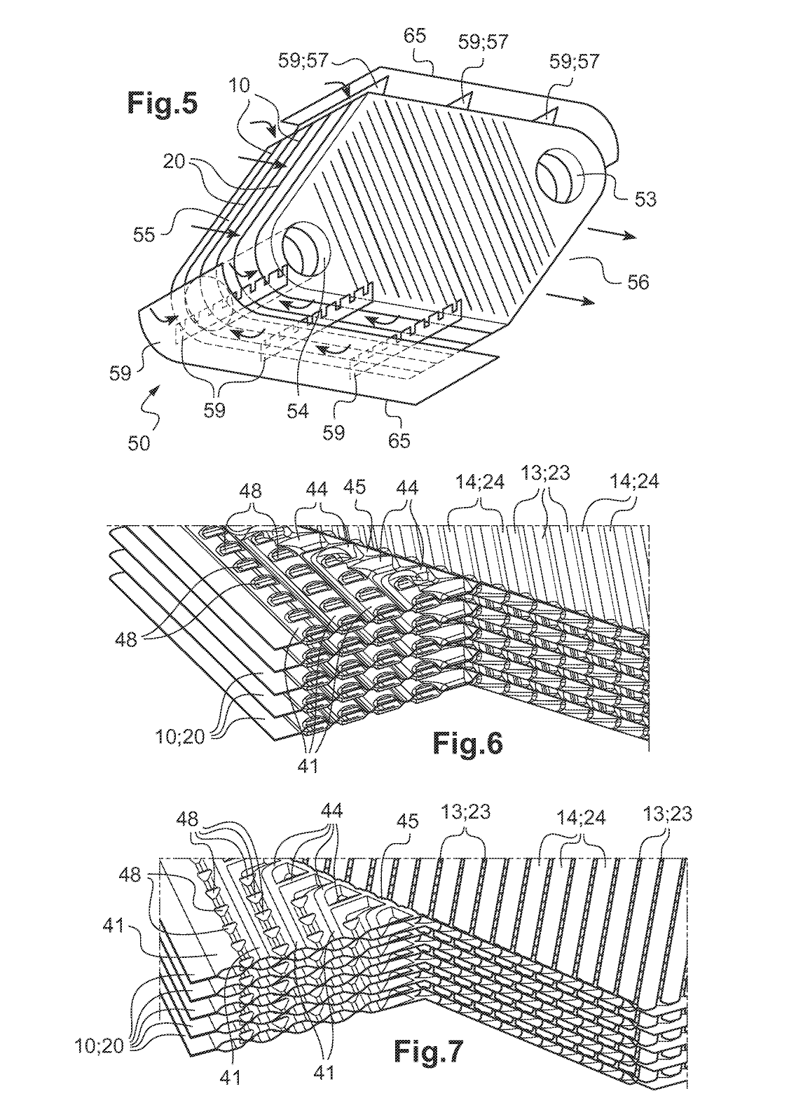

FIGS. 4 and 5 show a heat exchanger 50 constituted by stacking the modules 30. This stack is placed inside a casing 60 having a wall 65 in which there are arranged an inlet 55 and an outlet 56 of the heat exchanger 50.

The space between two plates 10 and 20 of a module 30 form a first cavity 51. The first cavities 51 are connected together by the inlet and outlet pipes 53 and 54. The space between two adjacent modules 30 forms a second cavity 52, as does the space between an extreme module 30 and a wall 65. A third cavity 58 is constituted by the space situated between the peripheral zones 19 of the modules 30 and the walls 65 of the casing 60. The second cavities 52 are connected together in particular via the inlet 55 and the outlet 56 of the heat exchanger 50, and also via the third cavity 58.

A first fluid enters into the heat exchanger 50 via the inlet pipe 53 and leaves the heat exchanger 50 via the outlet pipe 54, so it flows in the first cavities 51. A second fluid enters into the heat exchanger 50 via the inlet 55 and leaves the heat exchanger 50 via the outlet 56, so it flows in the second cavities 52 parallel to and preferably in the opposite direction to the first fluid. The flow of the second fluid is limited by the walls 65 of the casing 60. The second fluid may also flow in the third cavity 58.

Thus, the first and second fluids pass through the heat exchanger 50 while exchanging heat between each other. In addition, the plates 10, 20 are of thickness that is sufficiently small to enable heat exchange to take place between the first and second fluids independently of the capacity of the plates 10 and 20 for conducting heat.

In the heat exchanger 50, the directions of the troughs 14, 24 and of the ridges 13, 23 of each plate 10, 20 form a first angle β with the flow direction of the fluids, as shown in FIG. 2.

Each plate 10, 20 has two distribution zones 40, 40′ having channels 41. A first distribution zone 40 is situated between the crenellated inner zone 15 and the inlet chimney 11 so as to make it easier to fill a module 30 with the first fluid. Likewise, a second distribution zone 40′ is situated between the crenellated inner zone 15 and the outlet chimney 12 so as to make it easier to discharge the first fluid from the module 30.

These distribution zones 40, 40′ are narrow so that the crenellated inner zone 15 is as large as possible, thereby maximizing heat exchange between the first and second fluids.

The distribution zones 40, 40′ may be subdivided into two portions 45, 46, as shown in FIG. 1 for the first distribution zone 40. A first portion 45 is constituted by the space situated between the inlet chimney 11 and the crenellated inner zone 15 in the flow direction of the first fluid. The second portion 46 is constituted by the remainder of the first distribution zone 40, outside the first portion 45.

Since the first portion 45 of the first distribution zone 40 is situated between the inlet chimney 11 and the crenellated inner zone 15, the channels 41 are oriented parallel to the flow direction of the first fluid in this first portion 45 so as to feed the crenellated inner zone 15.

In contrast, in the second portion 46 of the first distribution zone 40, it is not possible to go directly from the inlet chimney 11 to the crenellated inner zone 15 in the flow direction of the first fluid through the heat exchanger 50. The channels 41 therefore extend initially from the inlet chimney 11 in a manner that is inclined relative to the flow direction of the first fluid through the heat exchanger 50 so as to be able to feed all of the crenellated inner zone 15 that faces this second portion 46. Thereafter, the channels 41 extend parallel to the flow direction of the first fluid in the proximity of the crenellated inner zone 15 so as to feed the crenellated inner zone 15.

The positions and the orientations of the channels 41 in the second distribution zone 40′ between the outlet chimney 12 and the crenellated inner zone 15 are similar to those of the channels 41 of the first distribution zone 40 between the inlet chimney 11 and the crenellated inner zone 15.

FIGS. 6 and 7 are detail views in section of a distribution zone 40 involving assembled-together plates 10 and 20.

In a module 30, the channels 41 of the two plates 10 and 20 face one another, the channels 41 of the distribution zone 40 of these two plates 10 and 20 being parallel and identical. Thus, two channels 41 of these two plates 10, 20 form a duct in which the first fluid can flow in order to feed and discharge the crenellated inner zone 15.

The channels 41 may be of sections that differ depending on the area of the crenellated inner zone 15 that they feed. In addition, as shown in FIGS. 6 and 7, the depth of these channels 41 is constant and identical for each of them.

The channels 41 of the first portion 45 feed substantially equal first areas of the crenellated inner zone 15. These channels 41 of this first portion 45 are then of substantially equal first widths.

The channels 41 of the second portion 46 feed substantially equal second areas of the crenellated inner zone 15, which second areas are greater than the first areas. Consequently, the channels 41 of the second portion 46 have second widths that are substantially equal and greater than the first widths. Furthermore, the channels 41 of the second portion 46 split into pairs of secondary channels 44 in order to be effective in filling or discharging these second areas of the crenellated inner zone 15 in uniform manner, the secondary channels 44 leading to the crenellated inner zone 15. These secondary channels 44 are substantially parallel to the flow direction of the first fluid.

The distribution zone 40, 40′ also has a furrow 42 into which the channels 41 open out. This furrow 42 is situated at the junction between each distribution zone 40, 40′ and the crenellated inner zone 15. The troughs 14 and the ridges 13 of the crenellated inner zone 15 open out into at least one furrow 42 of at least one distribution zone 40, 40′ on either side of the crenellated inner zone 15. Thus, each furrow 42 also serves in uniform manner to fill or to discharge the troughs 14 and the ridges 13 of the crenellated inner zone 15 of a module 30 with the first fluid.

Each distribution zone 40, 40′ also has secondary ducts 48 that are substantially parallel to the flow direction of the first fluid and of the second fluid.

In a first variant of the heat exchanger shown in FIG. 6, these secondary ducts 48 are stamped projections oriented in a direction substantially parallel to the flow direction of the second fluid through the heat exchanger 50 and they are made on the channels 41 that are inclined relative to the flow direction of this second fluid. These secondary ducts 48 thus locally reduce the height of the channels 41. These secondary ducts 48 are offset relative to the secondary channels 44 and thus make it easier to pass the second fluid through each distribution zone 40, 40′. The head losses generated by each distribution zone 40, 40′ in the second fluid are thus reduced.

In a second variant of the heat exchanger, shown in FIG. 7, the secondary ducts 48 are stamped indentations oriented in a direction substantially parallel to the flow direction of the second fluid through the heat exchanger 50 and they are less deep than the channels 41. These secondary ducts 48 are situated between the channels 41 of the second portion 46 that are oriented in inclined manner relative to the flow direction of the first fluid and in continuity with the secondary channels 44. These secondary ducts 48 thus reduce the depth of the space between the channels 41. These secondary ducts 48 thus serve firstly to limit locally the appearance of turbulence, and consequently they serve to limit head losses in the second fluid, and secondly they enable the first fluid to flow between the channels 41.

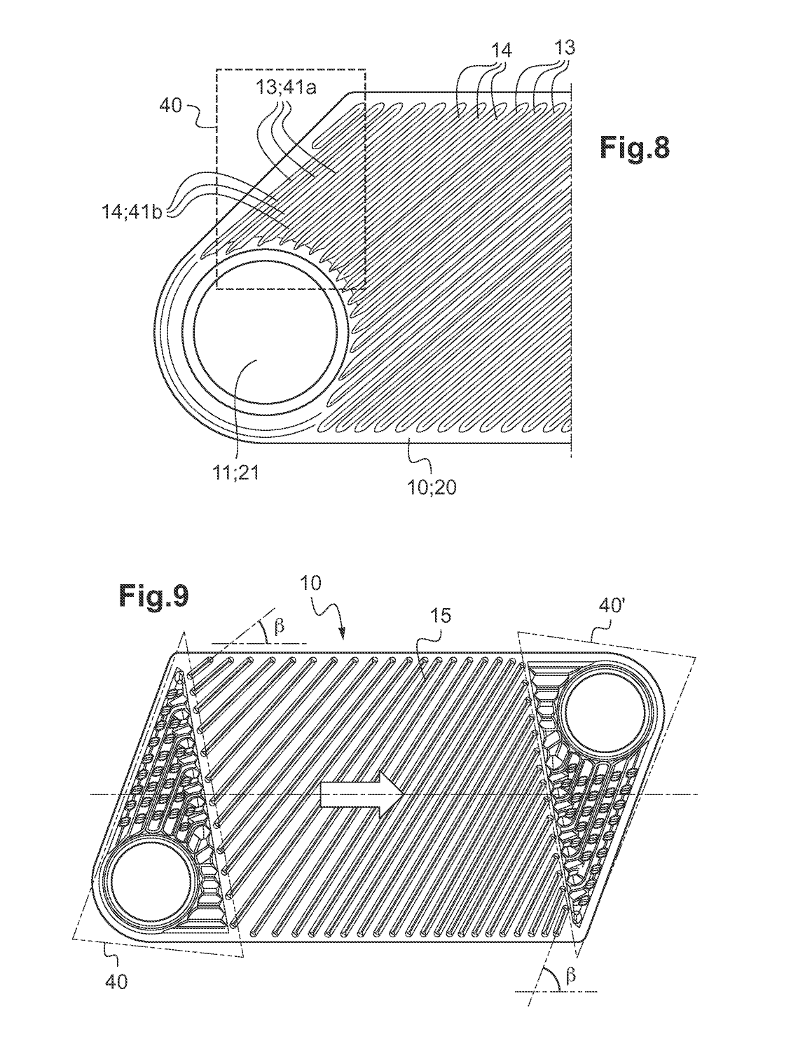

In another embodiment of the invention shown in FIG. 8, each channel 41 of the distribution zone 40 may be formed by a sinusoidal undulation having a distribution trough 41a and a distribution ridge 41b of shapes that are substantially identical to the troughs 14 and the ridges 13 of the crenellated inner zone 15. Each distribution trough 41a has a depth identical to the trough 14 of the crenellated inner zone 15, while each distribution ridge 41b has a height that is greater than the height of the ridges 13 in the crenellated inner zone 15, with this height decreasing down to the crenellated inner zone 15.

As shown in FIG. 8, the distribution zone 40 is then localized in the zone of the plate 10 that is located in a direction substantially perpendicular to the flow direction of the first fluid relative to the inlet chimney 11 or the outlet chimney 12. This distribution zone 40 is a zone where the first fluid tends not to go naturally. Thus, feeding or discharge of the crenellated inner zone 15 by the first fluid can be improved by having this height for the distribution ridge 41b, with this height decreasing over a few centimeters. For example, the difference in height between the distribution ridge 41b and the ridges 13 may lie at most in the range 0.5 mm to 1 mm, with this height decreasing over a length of 2 centimeters (cm) to 3 cm.

FIG. 5 shows combs 59 present in the third cavity 58 between the modules 30 and the walls 65 of the casing 60. These combs 59 serve to create head losses in the second fluid and to direct it towards the second cavities 52.

These combs 59 occupy the entire height between the walls 65 of the casing 60 and the modules 30 so as to constitute obstacles for the second fluid. The particular shape of these combs 59 also makes it possible to guarantee that the spacing between the modules 30 at the periphery of the modules 30.

These combs 59 could be replaced by flaps 57 that are movable between the modules 30 and a wall 65 of the casing 60. Thus, when the flaps 57 are closed, the second fluid cannot pass through the third cavity 58 and therefore passes mostly via the second cavity 52. In contrast, when the flaps 57 are open, the second fluid passes through the heat exchanger 50, while passing essentially via the third cavity 58 where it is subjected to very little head loss.

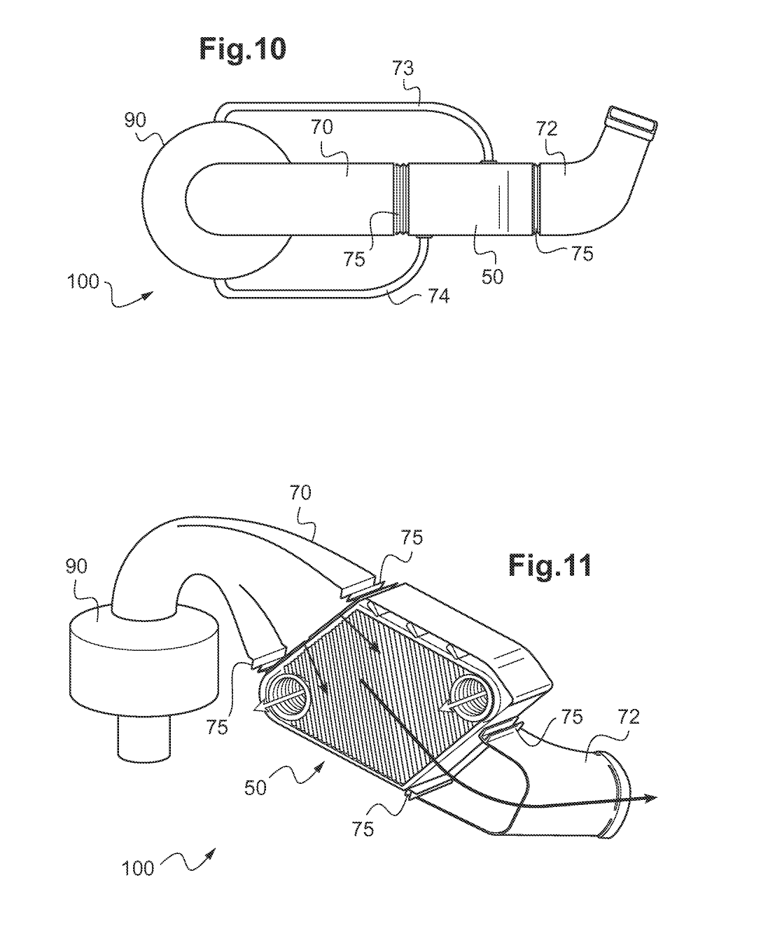

This operation is particularly useful when such a heat exchanger 50 is applied to a gas turbine 100, e.g. driving a rotary wing aircraft, with such a gas turbine 100 being shown in FIGS. 10 and 11. The first fluid may then be constituted by the air admitted into a combustion chamber 90 of the gas turbine 100 and the second fluid may be constituted by the exhaust gas leaving the combustion chamber 90 via an intermediate nozzle 70. The admission air flows through the modules 30 at high pressure, whereas the exhaust gas enters the heat exchanger 50 at very high temperature.

While the exhaust gas is passing through the second cavities 52 of the heat exchanger 50, it heats the admission air that also passes through the heat exchanger 50 via the first cavities 51. This serves to reduce the fuel consumption of the gas turbine 100 since the admission air is heated prior to being injected into the combustion chamber 90. However, the exhaust gas can be subjected to head losses on passing through the second cavities 52 prior to leaving the heat exchanger via an outlet nozzle 72. These head losses have a direct repercussion on the performance of the gas turbine 100 since its power is reduced.

In order to avoid such a reduction of power, it is necessary to reduce, and if possible to eliminate, head losses in the exhaust gas. For this purpose, the exhaust gas passes through the third cavity 58 of the heat exchanger 50 with the flaps 57 being open. Under such circumstances, the admission air is not heated and fuel consumption is therefore not reduced. However, since the exhaust gas is subjected to very little head loss, the gas turbine 100 then operates at maximum power.

Furthermore, in the heat exchanger 50 the first angle β between firstly the directions of the troughs 14, 24 and of the ridges 13, 23 of each plate 10, 20, and secondly the flow direction of the fluid can increase along a single plate 10, 20 in the flow direction of the first fluid through the heat exchanger 50, as shown in FIG. 9. This variation is identical for all of the plates 10, 20 of the heat exchanger 50. Consequently, the second angle θ between the troughs 14, 24 and the ridges 13, 23 of two adjacent plates 10, 20 is not zero and it too increases in the flow direction of the first fluid. The plates 10, 20 are assembled together in such a manner that the directions of their troughs 14, and of the ridges 13, 23 intersect so as to obtain a good comprise between heat exchange and head losses between the two fluids.

The variation in the first angle β thus makes it possible to compensate for the variation in the temperature of the first fluid as it advances through the heat exchanger 50 by making use of the turbulence to which the first fluid is subjected, thus making it possible to conserve a Reynolds' number Rₑ that is substantially constant. Consequently, heat exchange between the first and second fluids is optimized, with the Reynolds' number Rₑ of the first fluid being substantially constant throughout the heat exchanger 50.

FIG. 10 shows a plan view of the gas turbine 100. A cold volute 73 enables the admission air to flow from a compressor of the gas turbine 100 towards the inlet pipe 53. A hot volute 74 enables the admission air to flow from the outlet pipe 54 towards the combustion chamber 90 of the gas turbine 100.

It can also be seen in FIG. 11 that the heat exchanger 50 is positioned between the nozzles 70 and 72. In order to withstand thermal and mechanical stresses, and in particular in order to absorb expansions and vibration, while still providing the sealing needed for proper operation of the heat exchanger 50, metal bellows 75 are arranged at the junctions between the heat exchanger 50 and the various elements of the gas turbine 100. These bellows 75 are to be found in particular in association with the intermediate nozzle 70 and the outlet nozzle 72. Such bellows 75 may also be used with the inlet and outlet pipes 53 and 54 for the admission air, in association with the cold and hot volutes 73 and 74.

Naturally, the present invention may be subjected to numerous variations as to its implementation. Although several embodiments are described, it will readily be understood that it is not conceivable to identify in exhaustive manner all possible embodiments. It is naturally possible to envisage replacing any of the means described by equivalent means without going beyond the ambit of the present invention. In particular, the shapes of the troughs and the ridges in the plates could be different.

In particular, the troughs 14, 24 and the ridges 13, 23 of the plates 10, 20 which are of sinusoidal wave shape in all of the figures could be of other shapes, such as of squarewave shape or of trapezoidal wave shape. Likewise, these troughs 14, 24 and the ridges 13, 23 of the plates 10, 20 that extend in a single straight direction in all of the figures could extend in a plurality of intersecting directions over the plate as a whole. For example, the troughs 14, 24 and the ridges 13, 23 could follow sinuous paths of zigzag or squarewave shapes.

What is claimed is:

1. A plate heat exchanger comprising:
a plurality of modules, each formed by two metal plates, each plate having a peripheral zone, at least one inlet chimney, at least one outlet chimney, a crenellated inner zone comprising ridges and troughs, and at least two distribution zones located one between each inlet chimney and the crenellated inner zone, and the other between each outlet chimney and the crenellated inner zone, each distribution zone having channels between the crenellated inner zone and each inlet chimney or each outlet chimney, the two plates constituting a module being in contact firstly via the peripheral zones and secondly via points of contact of the troughs, at least one inlet pipe being formed by the inlet chimneys of each plate, and at least one outlet pipe being formed by the outlet chimneys of each plate, the modules being stacked in such a manner that two adjacent modules are in contact at least via the inlet chimneys and via the outlet chimneys, the directions of the troughs and of the ridges of each plate forming a first angle β with the flow direction of fluids flowing in the heat exchanger, and the directions of the troughs and of the ridges of two adjacent plates forming a non-zero second angle θ between one another;
a casing having walls within which the modules are received, an inlet and an outlet of the heat exchanger being arranged in the casing;
a first cavity constituted by the inside space of each module, a first fluid being capable of flowing in the first cavities between each inlet pipe and each outlet pipe;
a second cavity constituted by the space between two adjacent modules and by the space between each extreme module and a wall of the casing, a second fluid being capable of flowing in the second cavities between an inlet and an outlet of the heat exchanger; and
a third cavity constituted by the space situated between the peripheral zones of the modules and the walls;
wherein firstly the channels are parallel to the flow direction of the fluid for a first portion of the distribution zone, and secondly, for a second portion of the distribution zone, the channels are inclined relative to the flow direction of the first fluid in the proximity of the inlet or outlet chimney and parallel to the flow direction of the first fluid in the proximity of the crenellated inner zone in order to make the filling and the discharge of the modules by the first fluid more uniform, the first portion of the distribution zone being constituted by the space situated between the inlet or outlet chimney and the crenellated inner zone in the flow direction of the first fluid, the second portion of the distribution zone being constituted by the remainder of the distribution zone outside the first portion.

2. A heat exchanger according to claim 1, wherein the section of a first channel is larger than the section of a second channel if the first channel feeds a larger area of the crenellated inner zone than the second channel.

3. A heat exchanger according to claim 1, wherein a channel splits into a plurality of secondary channels, the secondary channels opening out into the crenellated inner zone, whereas the channel opens out into an inlet chimney or else an outlet chimney.

4. A heat exchanger according to claim 1, wherein each distribution zone includes a furrow into which the channels open out, the troughs and the ridges of the crenellated inner zone opening out on either side of the crenellated inner zone respectively into at least one furrow of at least one distribution zone.

5. A heat exchanger according to claim 1, wherein the distribution zone includes secondary ducts, the secondary ducts being indentations situated between the channels and oriented in the flow direction of the second fluid between the inlet and the outlet of the heat exchanger in order to limit the head losses generated in the second fluid.

6. A heat exchanger according to claim 1, wherein the distribution zone includes secondary ducts, the secondary ducts being projections situated on the channels and oriented in the flow direction of the second fluid between the inlet and the outlet of the heat exchanger in order to limit the head losses generated in the second fluid.

7. A heat exchanger according to claim 1, wherein the channels have distribution troughs and distribution ridges of shapes that are identical to the troughs and the ridges of the crenellated inner zone.

8. A heat exchanger according to claim 7, wherein the distribution ridges are of height greater than the ridges of the crenellated inner zone, the height of the distribution ridges decreasing from the inlet chimney or from the outlet chimney going towards the crenellated inner zone.

9. A heat exchanger according to claim 1, wherein the first angle β increases in the heat exchanger in the flow direction of the first fluid in the first cavities.

10. A heat exchanger according to claim 9, wherein the variation of the first angle β lies in the range 5° to 20° throughout the heat exchanger.

11. A heat exchanger according to claim 1, wherein the troughs and the ridges form V-shapes.

12. A heat exchanger according to claim 1, wherein the troughs and the ridges form straight lines.

13. A heat exchanger according to claim 1, wherein the directions of the troughs and of the ridges of two adjacent plates form between them a second angle θ lying in the range 60° to 120°.

14. A gas turbine, including a plate heat exchanger (50) according to claim 1.

15. A gas turbine according to claim 14, wherein the first fluid is compressed air feeding a combustion chamber of the turbine and the second fluid is constituted by the exhaust gas leaving the combustion chamber, the gas turbine having at least one cold volute enabling the admission air to flow from a compressor of the turbine to the inlet pipe, at least one hot volute enabling the admission air to flow from the outlet pipe to the combustion chamber, at least one intermediate nozzle enabling the exhaust gas from the combustion chamber to be directed to the inlet of the heat exchanger, and at least one outlet nozzle enabling the exhaust gas to be directed after exiting via the outlet of the heat exchanger.

16. A rotary wing aircraft, wherein the aircraft includes at least one gas turbine according to claim 14.
